(19) United States
(12) Patent Application Publication
(10) Pub. No.: US 2018/0116265 A1
(43) Pub. Date: May 3, 2018

(54) BLENDED HIGH-INTENSITY SWEETENER COMPOSITION

(71) Applicant: Morris IP Holdings LLC, Stokesdale, NC (US)

(72) Inventor: Philip G. MORRIS, Whitmore Lake, MI (US)

(73) Assignee: Morris IP Holdings LLC, Stokesdale, NC (US)

(21) Appl. No.: 15/339,739

(22) Filed: Oct. 31, 2016

(51) Int. Cl. A23L 27/30; A23L 33/105; A23L 33/125

(52) U.S. Cl. CPC A23L 27/33; A23V 2002/00; A23L 33/125; A23L 33/105

(57) ABSTRACT

A blended sweetener mixture that includes multiple high-intensity sweeteners, optionally combined with one or more bulk sweeteners such as sugar. Combining multiple high-intensity sweeteners creates synergistic effects on taste, while limiting the toxicity from any one ingredient. Mixtures of three or more high-intensity sweeteners may limit the sweetness contribution of any single ingredient to no more than 80% of the total sweetness of the mixture, and limit the sweetness contribution of any two ingredients to no more than 90% of the total sweetness of the mixture. Illustrative high-intensity sweeteners used in embodiments may include for example stevia, sucralose, neotame, and acesulfame potassium; illustrative bulk sweeteners may include for example bulk sugar, bulk powdered or agglomerated sugar, and bulk erythritol. Combinations of multiple high-intensity sweeteners and bulk sweeteners may for example provide effective sugar substitutes with equivalent or greater sweetness, lower calories, and lower glycemic loads.

### BACKGROUND OF THE INVENTION

### Field of the Invention

One or more embodiments of the invention are related to the field of sweeteners that are used in food and beverage products. More particularly, but not by way of limitation, one or more embodiments of the invention enable a blended high-intensity sweetener composition that combines multiple sweetening ingredients into a composition with improved taste and toxicity.

### Description of the Related Art

Several natural and artificial sweeteners are known in the art. Typically, these sweeteners are used alone rather than in combination. Occasionally two sweeteners are combined to form a binary blend.

Blending of multiple sweeteners provides at least two potential advantages. First, sweeteners act synergistically on taste receptors, so that a combination of different sweeteners tastes sweeter than the sum of the individual sweetness values of the ingredients. In addition, combinations may mitigate unusual tastes or aftertastes that occur with some high-intensity sweeteners. Second, by blending multiple sweeteners, the dosage of each individual sweetener is reduced, which reduces the potential toxicity of the blend. Toxicity is generally a function of the maximum dose of any one element; it is not generally additive across ingredients. Therefore, blending of multiple sweeteners can provide enhanced or equivalent sweetness at a lower toxicity. Some high-intensity sweeteners have raised toxicity concerns (notably saccharin, for example).

Also, many existing sweeteners, including some sugar substitutes, appear to be ineffective for weight loss; some studies have shown that some drinkers of zero calorie diet soda actually gain weight, rather than lose it. Moreover, many existing sweeteners lead to tooth decay. Blending of high-intensity sweeteners may also address these negative effects of existing sweeteners.

For at least the limitations described above there is a need for a blended high-intensity sweetener composition that combines multiple sweetening ingredients into a composition with improved taste and reduced toxicity. There is also a need for a blended high-intensity sweetener composition that promotes weight loss and that prevents tooth decay.

### BRIEF SUMMARY OF THE INVENTION

One or more embodiments described in the specification are related to a blended high-intensity sweetener composition. The blend combines multiple high-intensity sweeteners, optionally augmented with a bulk sweetener (such as sugar), into a compound sweetening mixture. One or more embodiments may use mixtures of two, three, four, or more high-intensity sweeteners. Embodiments may use various ratios of different high-intensity sweeteners. One or more embodiments may employ ratios that limit the sweetness contribution of any one or any two ingredients to the overall sweetness of the mixture, for example to 80% for a single ingredient or to 90% for any two ingredients. In a mixture with only two high-intensity sweeteners, one or more embodiments may for example limit the sweetness contribution of any one ingredient to 90% or less, so that each ingredient must contribute at least 10% to the sweetness of the mixture.

High-intensity sweeteners used in one or more embodiments may include for example, without limitation, saccharin, cyclamate, aspartame, acesulfame potassium, stevioside, rebaudioside, sucralose, neotame, advantame, monatin, brazzein, mogroside, alitame, curculin, glycyrrhizin, monellin, neohesperidin DC, pentadin, and thaumatin. Preferred high-intensity sweeteners in embodiments with only two sweeteners may include for example, without limitation, stevia, sucralose, neotame, advantame, monatin, brazzein, and mogroside.

One or more embodiments may add one or more bulk sweeteners to the mixture. Because of the high-intensity sweeteners in the mixture, the combination of the bulk sweetener and the high-intensity sweeteners may for example be used as a sugar substitute in lower quantities than sugar, while providing equivalent sweetness. One or more embodiments may use bulk sweeteners that are agglomerated to reduce their density.

Bulk sweeteners used in one or more embodiments may include for example, without limitation, sugar, sucrose, tagatose, brown sugar, fructose, high fructose corn syrup, corn sugar, corn sweetener, corn syrup, fructose glucose syrup, glucose fructose syrup, HFCS-42, HFCS-55, HFCS-90, high maltose corn syrup, maltodextrin, dextrose, saccharose, galactose, glucose, lactose, galactose, trehalose, inverted sugar, glycerol, glycerine, maltitol, isomalt, mannitol, lactitol, sorbitol, glucitol, xylitol, erythritol, hydrogenated starch hydrolysate, molasses, agave syrup, barley malt syrup, birch syrup, brown rice syrup, cane juice, caramel, coconut palm sugar, palm sugar, fructooligosaccharide, oligofructose, isomaltooligosaccharide, inulin, polydextrose, golden syrup, honey, maple syrup, rapadura, refiners syrup, sorghum syrup, and yacon syrup. Embodiments with erythritol may in particular have dental benefits, since the most recent large scale, long term studies show that erythritol demonstrates the highest level of tooth decay reduction among all sweeteners.

### DETAILED DESCRIPTION OF THE INVENTION

A blended high-intensity sweetener composition will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

Researchers generally characterize sweeteners by their sweetness intensity relative to sucrose solution (typically 2%). For example, sucralose is 600 times sweeter than sugar, and neotame is approximately 8,000 sweeter than sugar. Thus we say that the sweetness of sucralose is 600, and the sweetness of neotame is 8,000. A high-intensity sweetener typically has a sweetness of 10 or greater. The contribution of a specific sweetener to the total sweetness of a blend depends on both the sweetness of the sweetener and the proportion by mass of that sweetener in the blend. For example, in a blend of 50% sucralose by mass and 50% neotame by mass, the neotame makes a much larger contribution to the total sweetness of the sweetener because of its much higher sweetness compared to sucralose. Specifically, we can calculate a sweetness weight in the mixture for each sweetener ingredient as a product of that sweetener's sweetness and its mass in the mixture. Thus in the 50/50 blend of sucralose and neotame, the sweetness weight of sucralose is 600×50%=300, and the sweetness weight of neotame is 8,000×50%=4,000. The sweetness fraction of each ingredient in the mixture is then defined as its sweetness weight divided by the total sweetness weight for all ingredients. Thus in the 50/50 blend of sucralose and neotame, the sweetness fraction of sucralose is 300/4300=about 7%, and the sweetness fraction of neotame is 4000/4300=about 93%.

One or more embodiments of the invention comprise a mixture of high-intensity sweeteners, where a high-intensity sweetener is defined as a sweetener with sweetness at least ten times as great as the sweetness of sugar. One or more embodiments comprise a mixture of three or more different high-intensity sweeteners. One or more embodiments comprise a mixture of four or more different high-intensity sweeteners. In these mixtures of three, four, or more high-intensity sweeteners, one or more embodiments may use combinations where each individual sweetener has a sweetness fraction of 80% or lower in the mixture, and any two sweeteners have a combined sweetness fraction of 90% or lower in the mixture.

Embodiments comprising mixtures of high-intensity sweeteners may be added directly to foods and beverages, for examples by industrial food processors. They may also be added to water for droplet dispensing, or added to bulk sweeteners such as sugar for baking or other consumer uses.

We now describe several illustrative embodiments using specific sweeteners and specific mixture ratios. These examples are for illustration only. Variations on these embodiments using different sweeteners, different mass ratios, and different sweetness fractions are in keeping with the spirit of the invention.

An illustrative embodiment of the invention that comprises a mixture of three high-intensity sweeteners is as follows:

| Ingredient | Mass Ratio | Sweetness Fraction |
|---|---|---|
| Stevia | 17 | 35% |
| Sucralose | 16 | 35% |
| Neotame | 1 | 30% |

This mixture has an overall sweetness of 900 (compared to sugar). The stevia used in this embodiment (and in other embodiments described below) may be any blend of stevioside and rebaudioside, with highly refined rebaudioside preferred above 70%.

An illustrative embodiment of the invention that comprises a mixture of four high-intensity sweeteners is as follows:

| Ingredient | Mass Ratio | Sweetness Fraction |
|---|---|---|
| Stevia | 16 | 30% |
| Sucralose | 15 | 30% |
| Neotame | 1 | 30% |
| Acesulfame | 15 | 10% |
| Potassium | | |

This mixture has an overall sweetness of 600 (compared to sugar). The stevia used in this embodiment (and in other embodiments described below) may be any blend of stevioside and rebaudioside, with highly refined rebaudioside preferred above 70%. Below we will refer to this mixture as the “quaternary 600× mixture.”

One or more embodiments may combine a mixture of high-intensity sweeteners with one or more bulk sweeteners. The bulk sweetener or bulk sweeteners may optionally be agglomerated to reduce their density, for example to create a light, fluffy bulking powder. Below we describe some illustrative embodiments with bulk sweeteners using the quaternary 600× mixture described above as the high-intensity sweetener mixture. One or more embodiments may use any high-intensity sweetener mixture in combination with the bulk sweeteners described below, or in combination with any other bulk sweeteners. For example, one or more embodiments may use the tertiary mixture above with the bulk sweetener ratios described below.

An illustrative embodiment that combines a high-intensity sweetener mixture with a bulk sweetener is as follows:

| Ingredient | Mass Ratio | Sweetness Fraction |
|---|---|---|
| Quaternary 600x mixture | 1 | 75% |
| Bulk sugar | 200 | 25% |

This mixture is 4 times sweeter than pure sugar by mass. It has 4 calories per ¼ teaspoon serving, thus qualifying as a zero-calorie sweetener per the Food and Drug Administration, despite being bulked with sugar. A variation on this embodiment uses agglomerated bulk sugar that is reduced in density by a factor of 4 compared to normal bulk sugar. This mixture with agglomerated bulk sugar has equivalent sweetness to normal sugar by volume, but with one quarter the calories since it has less sugar by mass. This mixture may be useful for example in baking since normal volume measures for recipes can be used without changes.

A variation on the above embodiment uses powdered bulk sugar:

| Ingredient | Mass Ratio | Sweetness Fraction |
|---|---|---|
| Quaternary 600x mixture | 1 | 86% |
| Bulk powdered sugar | 100 | 14% |

This mixture has 2.4 calories per ¼ teaspoon serving, because the powdered bulk sugar is less dense than normal granulated sugar. The calories are about the same as Splenda®, but with a 20% lower glycemic load.

Another illustrative embodiment uses a higher fraction of sugar by mass:

| Ingredient | Mass Ratio | Sweetness Fraction |
|---|---|---|
| Quaternary 600x mixture | 1 | 50% |
| Bulk sugar | 600 | 50% |

This embodiment has twice the sweetness of normal sugar. It may be useful for example for baking.

Any bulk sweetener or combination of bulk sweeteners may be combined with a high-intensity sweetener mixture. An illustrative embodiment using bulk erythritol is as follows:

| Ingredient | Mass Ratio | Sweetness Fraction |
|---|---|---|
| Quaternary 600x mixture | 1 | 83% |
| Bulk erythritol | 180 | 17% |

This embodiment has 0.2 calories per ¼ teaspoon, and a glycemic load of about 0.002, which is virtually zero. It may therefore be useful for example for diabetics who carefully monitor their glycemic load. It may also be useful for example for preventing tooth decay, since erythritol appears to lead to less tooth decay than other sweeteners.

While the invention herein disclosed has been described by means of specific embodiments and applications thereof, numerous modifications and variations could be made thereto by those skilled in the art without departing from the scope of the invention set forth in the claims.

What is claimed is:

1. A blended high-intensity sweetener composition comprising:
a mixture of a plurality of high intensity sweeteners, wherein
said plurality of high intensity sweeteners comprises three or more different high intensity sweeteners;
each high intensity sweetener of said plurality of high intensity sweeteners has a sweetness greater than ten times that of sucrose;
each high intensity sweetener of said plurality of high intensity sweeteners has
a weighted sweetness in said mixture that is said sweetness of said high intensity sweetener multiplied by a mass of said high intensity sweetener in said mixture; and,
a sweetness fraction in said mixture that is said weighted sweetness for said high intensity sweetener divided by a total of said weighted sweetness across said plurality of high intensity sweeteners in said mixture;
said sweetness fraction is 80% or lower for each high intensity sweetener of said plurality of high intensity sweeteners;
the sum of said sweetness fraction of any two of said plurality of high intensity sweeteners is 90% or lower; and,
said three or more different high intensity sweeteners comprises
a first high intensity sweetener with a mass ratio of 16 or 17 and a sweetness fraction of 30% or 35% respectively,
a second high intensity sweetener with a mass ratio of 15 or 16 and a sweetness fraction of 30% or 35% respectively, and
a third high intensity sweetener with a mass ratio of 1 and a sweetness fraction of 30%; and,
a bulk sweetener,
wherein said bulk sweetener is agglomerated to reduce its density by a factor of 3 or more compared to bulk sweetener that is not agglomerated, to create a light fluffy bulking powder; and,
wherein said bulk sweetener comprises a mass ratio of 100, 180, 200 or 600 and a sweetness fraction of 14%, 17%, 25% or 50% respectively;
wherein each of said three or more different high intensity sweeteners is selected from the group consisting of saccharin, cyclamate, aspartame, acesulfame potassium, stevioside, rebaudioside, sucralose, neotame, advantame, monatin, brazzein, mogroside, alitame, curculin, glycyrrhizin, monellin, neohesperidin DC, pentadin, and thaumatin.

2. (canceled)

3. The blended high-intensity sweetener composition of claim 1, wherein said three or more different high intensity sweeteners comprises four or more different high intensity sweeteners.

4. The blended high-intensity sweetener composition of claim 1, wherein said three or more different high intensity sweeteners comprises four or more different high intensity sweeteners with a fourth high intensity sweetener with a mass ratio of 15 and a sweetness fraction of 10%.

5. (canceled)

6. The blended high-intensity sweetener composition of claim 1, wherein said bulk sweetener is selected from the group consisting of sugar, sucrose, tagatose, brown sugar, fructose, high fructose corn syrup, corn sugar, corn sweetener, corn syrup, fructose glucose syrup, glucose fructose syrup, HFCS-42, HFCS-55, HFCS-90, high maltose corn syrup, maltodextrin, dextrose, saccharose, galactose, glucose, lactose, galactose, trehalose, inverted sugar, glycerol, glycerine, maltitol, isomalt, mannitol, lactitol, sorbitol, glucitol, xylitol, erythritol, hydrogenated starch hydrolysate, molasses, agave syrup, barley malt syrup, birch syrup, brown rice syrup, cane juice, caramel, coconut palm sugar, palm sugar, fructooligosaccharide, oligofructose, isomaltooligosaccharide, inulin, polydextrose, golden syrup, honey, maple syrup, rapadura, refiners syrup, sorghum syrup, and yacon syrup.

7. (canceled)

8. The blended high-intensity sweetener composition of claim 1, wherein
said plurality of high intensity sweeteners consists of stevia, sucralose, and neotame.

9. (canceled)

10. The blended high-intensity sweetener composition of claim 4, wherein
said four or more different high intensity sweeteners consists of stevia, sucralose, neotame, and acesulfame potassium.

11. (canceled)

12. The blended high-intensity sweetener composition of claim 10, wherein
said bulk sweetener comprises one or more of bulk sugar and bulk high fructose corn syrup; and,
a ratio of a mass of said plurality of high intensity sweeteners to a mass of said bulk sweetener is between 1:150 and 1:250.

13. (canceled)

14. The blended high-intensity sweetener composition of claim 12, wherein
a sweetness of a volume quantity of said mixture is approximately equal to a sweetness of said volume quantity of pure sugar that is not agglomerated.

15. The blended high-intensity sweetener composition of claim 10, wherein
said bulk sweetener comprises one or more of bulk sugar and bulk high fructose corn syrup; and,
a ratio of a mass of said plurality of high intensity sweeteners to a mass of said bulk sweetener is between 1:500 and 1:700.

16. The blended high-intensity sweetener composition of claim 10, wherein said bulk sweetener comprises bulk powdered sugar, and wherein a ratio of a mass of said plurality of high intensity sweeteners to a mass of said bulk powdered sugar is between 1:75 and 1:125.

17. The blended high-intensity sweetener composition of claim 10, wherein said bulk sweetener comprises bulk erythritol, wherein
a ratio of a mass of said plurality of high intensity sweeteners to a mass of said bulk erythritol is between 1:150 and 1:210.

18. A blended high-intensity sweetener composition consisting of:
a mixture of four different high intensity sweeteners, wherein
each high intensity sweetener of said four different high intensity sweeteners has
a weighted sweetness in said mixture that is said sweetness of said high intensity sweetener multiplied by a mass of said high intensity sweetener in said mixture; and,
a sweetness fraction in said mixture that is said weighted sweetness divided by a total of said weighted sweetness across said four different high intensity sweeteners in said mixture;
said sweetness fraction is 10% or greater for each high intensity sweetener of said four different high intensity sweeteners; and,
said four different high intensity sweeteners consists of
a first high intensity sweetener of said four different high intensity sweeteners is stevia with a mass ratio of 16 and a sweetness fraction of 30%,
a second high intensity sweetener of said four different high intensity sweeteners is sucralose with a mass ratio of 15 and a sweetness fraction of 30%,
a third high intensity sweetener of said four different high intensity sweeteners is neotame with a mass ratio of 1 and a sweetness fraction of 30%, and
a fourth high intensity sweetener of said four different high intensity sweeteners is acesulfame potassium with a mass ratio of 15 and a sweetness fraction of 10%; and
said mixture of four different high intensity sweeteners has an overall sweetness of 600 times sweeter compared to sugar; and,
a bulk sweetener,
wherein said bulk sweetener is agglomerated to reduce its density by a factor of 3 or more compared to bulk sweetener that is not agglomerated, to create a light fluffy bulking powder; and,
wherein said bulk sweetener comprises a mass ratio of 100, 180, 200 or 600 and a sweetness fraction of 14%, 17%, 25% or 50% respectively;
wherein said mixture of said four different high intensity sweeteners has a mass ratio of 1, and
wherein said mixture of said four different high intensity sweeteners has a sweetness fraction of 75% or 86% or 50% or 83% and wherein said bulk sweetener has a sweetness fraction of 20% or 14% or 50% or 17% respectively.

19. (canceled)

20. The blended high-intensity sweetener composition of claim 18, wherein said bulk sweetener is selected from the group consisting of sugar, sucrose, tagatose, brown sugar, fructose, high fructose corn syrup, corn sugar, corn sweetener, corn syrup, fructose glucose syrup, glucose fructose syrup, HFCS-42, HFCS-55, HFCS-90, high maltose corn syrup, maltodextrin, dextrose, saccharose, galactose, glucose, lactose, galactose, trehalose, inverted sugar, glycerol, glycerine, maltitol, isomalt, mannitol, lactitol, sorbitol, glucitol, xylitol, erythritol, hydrogenated starch hydrolysate, molasses, agave syrup, barley malt syrup, birch syrup, brown rice syrup, cane juice, caramel, coconut palm sugar, palm sugar, fructooligosaccharide, oligofructose, isomaltooligosaccharide, inulin, polydextrose, golden syrup, honey, maple syrup, rapadura, refiners syrup, sorghum syrup, and yacon syrup.

21. The blended high-intensity sweetener composition of claim 1, wherein said mixture of a plurality of high intensity sweeteners consists of three different high intensity sweeteners, wherein said first high intensity sweetener is stevia with a mass ratio of 17 and a sweetness fraction of 35%, wherein said second high intensity sweetener is sucralose with a mass ratio of 16 and a sweetness fraction of 35%, wherein said third high intensity sweetener is neotame with a mass ratio of 1 and a sweetness fraction of 30%, and wherein said mixture of three different high intensity sweeteners has an overall sweetness of 900 times sweeter compared to sugar.

22. The blended high-intensity sweetener composition of claim 1, wherein said mixture of a plurality of high intensity sweeteners consists of four different high intensity sweeteners, wherein said first high intensity sweetener is stevia with a mass ratio of 16 and a sweetness fraction of 30%, wherein said second high intensity sweetener is sucralose with a mass ratio of 15 and a sweetness fraction of 30%, wherein said third high intensity sweetener is neotame with a mass ratio of 1 and a sweetness fraction of 30%, wherein a fourth high intensity sweetener is acesulfame potassium with a mass ratio of 15 and a sweetness fraction of 10%, and wherein said mixture of four different high intensity sweeteners has an overall sweetness of 600 times sweeter compared to sugar.

23. The blended high-intensity sweetener composition of claim 22, wherein said mixture of said four different high intensity sweeteners has a mass ratio of 1 and a sweetness fraction of 75%, wherein said bulk sweetener is bulk sugar with a mass ratio of 200 and a sweetness fraction of 25%, and wherein said bulk sugar is agglomerated such that said mixture of said four different high intensity sweeteners with said bulk sugar has equivalent sweetness to sugar by volume and has one quarter calories compared to calories of sugar.

24. The blended high-intensity sweetener composition of claim 22, wherein said mixture of said four different high intensity sweeteners has a mass ratio of 1 and a sweetness fraction of 86%, and wherein said bulk sweetener is bulk powdered sugar with a mass ratio of 100 and a sweetness fraction of 14%.

25. The blended high-intensity sweetener composition of claim 22, wherein said mixture of said four different high intensity sweeteners has a mass ratio of 1 and a sweetness fraction of 50%, and wherein said bulk sweetener is bulk sugar with a mass ratio of 600 and a sweetness fraction of 50%.

26. The blended high-intensity sweetener composition of claim 22, wherein said mixture of said four different high intensity sweeteners has a mass ratio of 1 and a sweetness fraction of 83%, wherein said bulk sweetener is bulk erythritol with a mass ratio of 180 and a sweetness fraction of 17%, and wherein said mixture of said four different high intensity sweeteners with said bulk erythritol has 0.2 calories per one quarter teaspoon and a glycemic load of about 0.002.
